(19) United States
(12) Patent Application Publication
(10) Pub. No.: US 2009/0264210 A1
(43) Pub. Date: Oct. 22, 2009

(54) Titanium alloy fasteners and the related fabricating method

(76) Inventor: Kern-Hsiung Huang, Kwan Miao Hsiang (TW)

Correspondence Address: PRO-TECHTOR INTERNATIONAL SERVICES, 20775 NORADA CT., SARATOGA, CA, 95070, US

(21) Appl. No.: 12/185,351

(22) Filed: Aug. 4, 2008

(30) Foreign Application Priority Data
Apr. 18, 2008 (TW) 097114241

(51) Int. Cl. B21H 3/00; F16B 25/10

(52) U.S. Cl. 470/9; 411/387.1

(57) ABSTRACT

A titanium alloy fastener made by: using titanium alloy to make a fastener body subject to a predetermined design, and then applying a heat treatment to harden the fastener body, and then processing the fastener body with a nitrogen treatment to form a titanium nitride coating on the whole surface of the fastener body.

### BACKGROUND OF THE INVENTION

1. Field of the Invention

The present invention relates to a titanium alloy fastener fabrication method for making a titanium alloy fastener, for example, screw bolt, nut or self-tapping screw that comprises a titanium alloy fastener body hardened through a heat treatment and a titanium nitride coating formed on the whole surface of the fastener body through a nitrogen treatment.

2. Description of the Related Art

Conventional screw fasteners 10, such as screw bolts 101 or nuts 102 (see FIG. 1) or self-tapping screws 104 (see FIG. 2) are commonly made of metal and processed through a heat treatment to improve the hardness.

The aforesaid conventional screw fasteners 10 may be made of soft ferrite by means of press forging. However, soft ferrite is easy to get oxidized and has low strength and ability to resist acid and alkali salt. To provide a better strength, a screw fastener 10 may be made of a high hardness material. However, the hardness of a ferrite series material is subject to its carbon content. A ferrite series material of low carbon content has a relatively higher hardness, however it is relatively fragile. A self-tapping screw 104 made of a ferrite series material having high hardness may break easily when it is driven into metal plate members 50.

Therefore, it is desirable to provide a screw fastener that eliminates the aforesaid problems.

### SUMMARY OF THE INVENTION

The present invention has been accomplished under the circumstances in view. It is one object of the present invention to provide a titanium alloy fastener, which effectively eliminates fragility, rust and corrosion problems of conventional screw fasteners. It is another object of the present invention to provide a titanium alloy fasteners which has hard, tough, fatigue-limited, lightweight, acid and alkali proof, rustproof and carbon-free material properties. It is still another object of the present invention to provide a titanium alloy fastener fabrication method, which is practical for making a titanium alloy fastener that effectively eliminates fragility, rust and corrosion problems of conventional screw fasteners and, that has hard, tough, fatigue-limited, lightweight, acid and alkali proof, rustproof and carbon-free material properties.

According to the present invention, a titanium alloy fastener fabrication method comprises the steps of a) using titanium alloy to make a fastener body subject to a predetermined design, b) applying a heal treatment to the fastener body to harden the fastener body, and c) applying a nitrogen treatment to the fastener body to form a titanium nitride coating on the whole surface of the fastener body.

Further, the heat treatment may be repeated to enhance the hardness of the fastener body.

Further, the titanium nitride coating has a hardness around 2000 HV to 3500 HV.

Further, the titanium alloy fastener can be a screw bolt, a nut, or a self-tapping screw.

### BRIEF DESCRIPTION OF THE DRAWINGS

FIG. 1 is an elevational view of a conventional screw and a conventional nut.

FIG. 2 illustrates an application example of a conventional self-tapping screw.

FIG. 3 is a fabrication flow showing the fabrication of a titanium alloy screw bolt in accordance with a first embodiment of the present invention.

FIG. 4 is a fabrication flow showing the fabrication of a titanium alloy screw bolt in accordance with a second embodiment of the present invention.

FIG. 5 is a fabrication flow showing the fabrication of a titanium alloy screw nut in accordance with the second embodiment of the present invention.

FIG. 6 is a plain view of a self-tapping screw made according to the present invention.

FIG. 7 is an applied view of the self-tapping screw shown in FIG. 6.

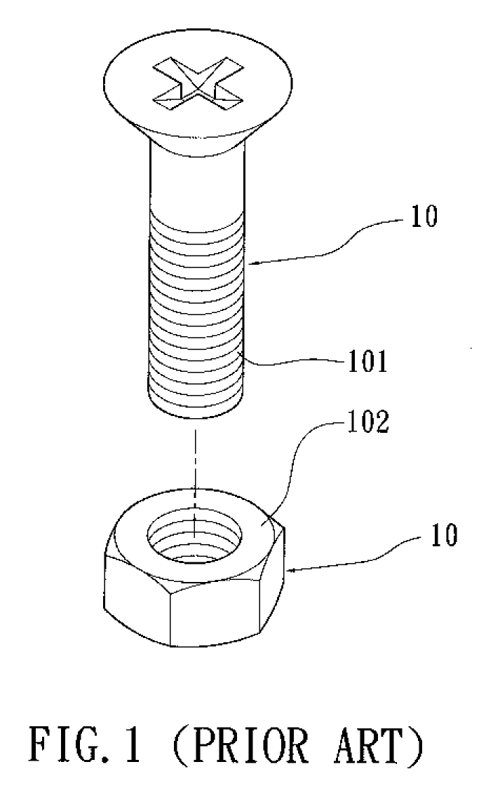

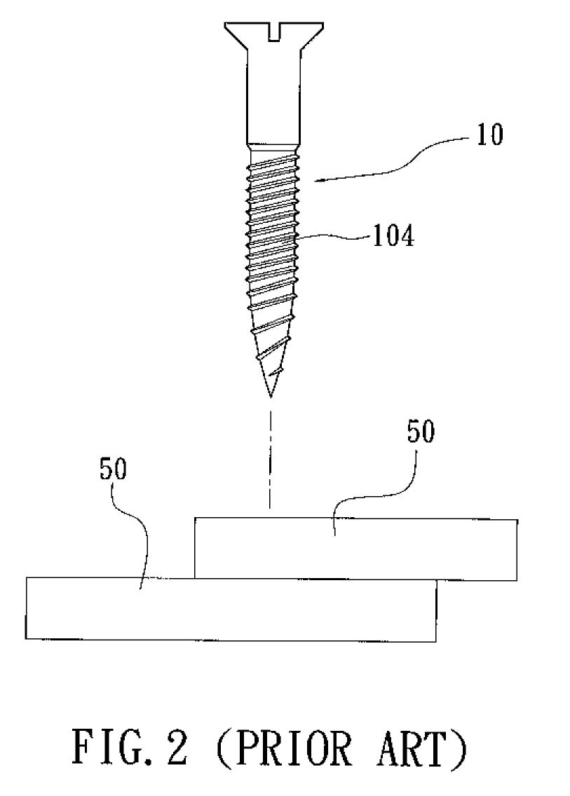

### DETAILED DESCRIPTION OF THE PREFERRED EMBODIMENT

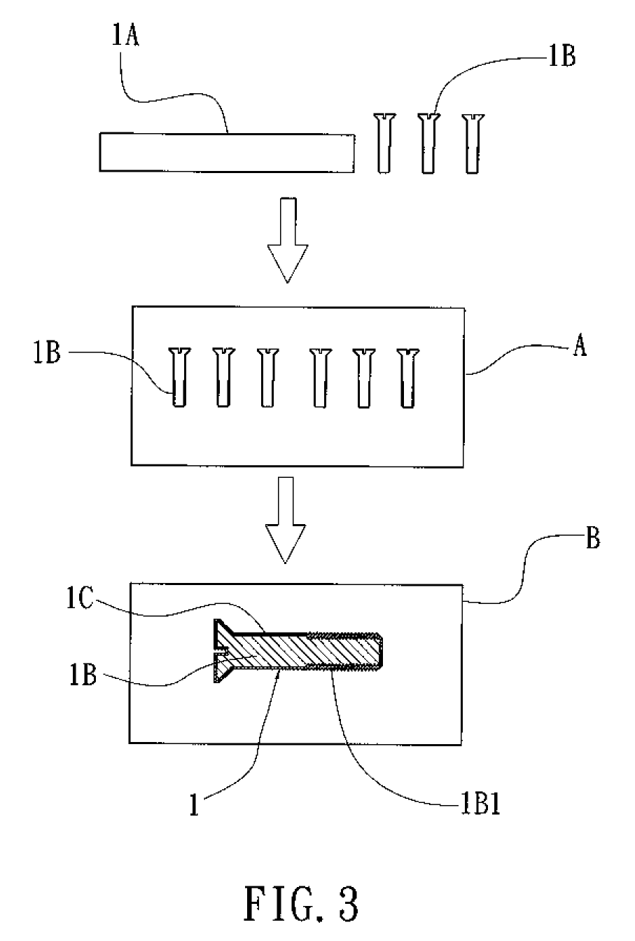

Referring to FIG. 3, a method for making titanium alloy fasteners 1 such as titanium alloy screw bolts, titanium alloy self-tapping screws, titanium alloy nuts in accordance with a first embodiment of the present invention comprising the steps of:

Step I: using titanium alloy 1A to make fastener bodies 1B.

Step II: hardening each fastener body 1B by means of a heat treatment A.

Step III: processing each hardened fastener body 1B with a nitrogen treatment B to form a titanium nitride coating 1C on the surface of each fastener body 1B, and thus the desired titanium alloy fasteners 1 are obtained.

As stated above, a titanium alloy fastener 1 is made by means of: making a fastener body 1B having threads 1B1 from titanium alloy IA subject to a predetermined design, and then treating the fastener body 1B with a beat treatment A to harden the fastener body 1B, and then treating the hardened fastener body 1B with a nitrogen treatment B. After the nitrogen treatment B, a high-hardness titanium nitride coating 1C is formed on the surface of the fastener body 1B, and thus the desired titanium alloy fastener 1 is obtained. Because the fastener body 1B contains no carbon, it has excellent toughness after having been hardened. After the nitrogen treatment B, the titanium nitride coating 1C that is formed on the surface of the fastener body 1 has a hardness around 2000 HV to 3500 HV. Therefore, a titanium alloy fastener 1 made according to the present invention has a combination of high hardness and toughness.

Further, because the fastener body 1B of each titanium alloy fastener 1 is prepared from titanium alloy 1A, it has hard, tough, fatigue-limited, lightweight, acid and alkali proof, rustproof and carbon-free material properties.

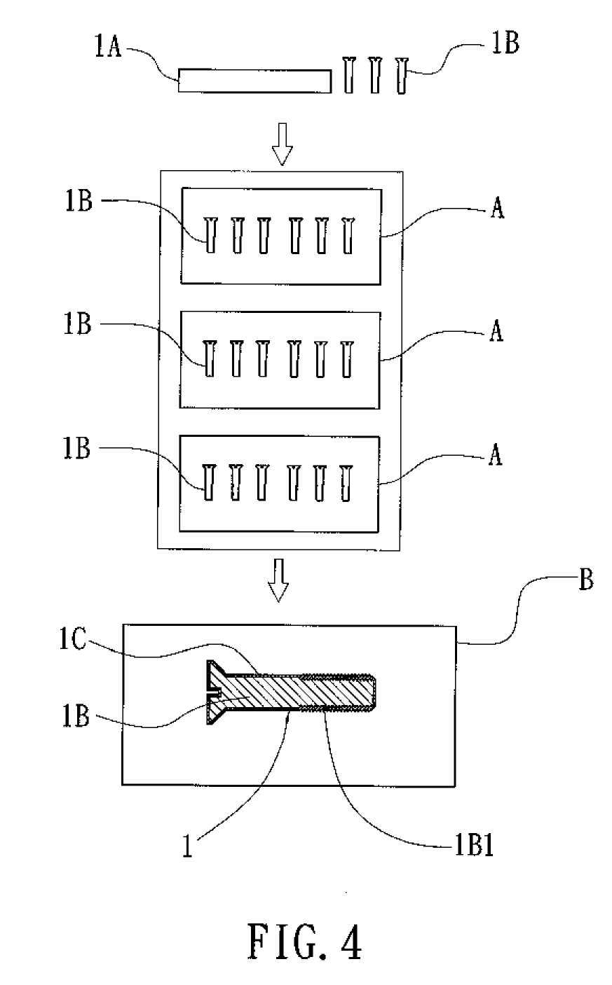

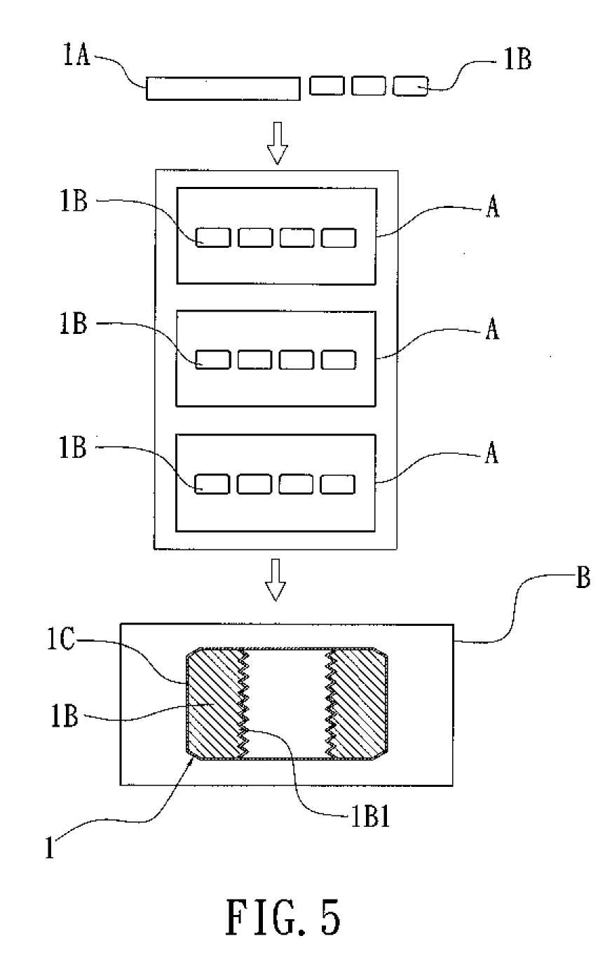

Referring to FIGS. 4 and 5, a method for making titanium alloy fasteners 1 such as titanium alloy screw bolts, titanium alloy self-tapping screws, titanium alloy nuts in accordance with a second embodiment of the present invention comprising the steps of:

Step I: using titanium alloy 1A to make fastener bodies 1B.

Step II: hardening each fastener body 1B by means of a heat treatment A and then repeating the hardening process at least once, for example twice.

Step III: processing each hardened fastener body 1B with a nitrogen treatment B to form a titanium nitride coating 1C on the surface of each fastener body 1B, and thus the desired titanium alloy fasteners 1 are obtained.

Further, the titanium alloy fasteners 1 can be screw bolts (see FIG. 4), or screw nuts (see FIG. 5).

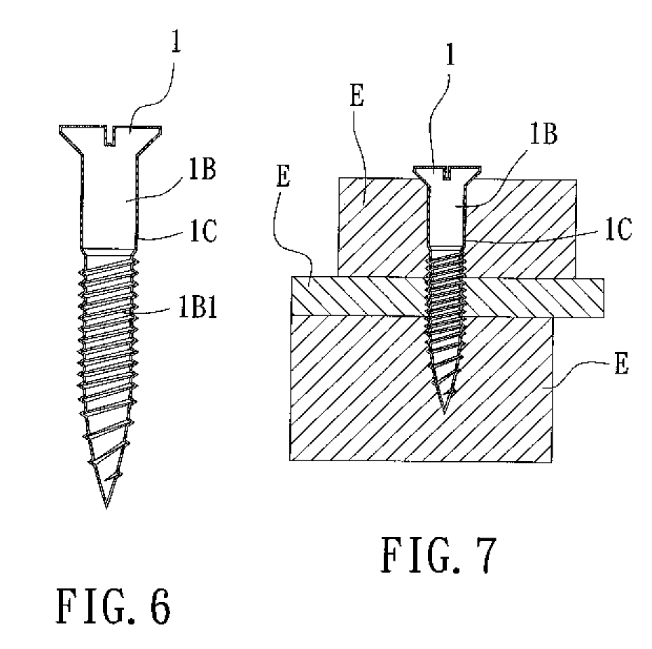

Referring to FIGS. 6 and 7, a titanium alloy fastener 1 made in accordance with either of the aforesaid two embodiments can be a self-tapping screw (see FIG. 6) that can be driven into metal plate members E to secure the metal plate members E together (see FIG. 7).

In general, a titanium alloy fastener 1 in accordance with the present invention is made by means of: making a fastener body 1B having threads 1B1 from titanium alloy 1A subject to a predetermined design, and than treating the fastener body 1B with a heat treatment A to harden the fastener body 1B and repeating the heat treatment A once or twice to enhance the hardness, if necessary, and then treating the hardened fastener body 1B with a nitrogen treatment B. After the nitrogen treatment B, a high-hardness titanium nitride coating 1C is formed on the surface of the fastener body 1B, and thus the desired titanium alloy fastener 1 is obtained. The finished titanium alloy fastener 1 has excellent toughness. After the nitrogen treatment B, the titanium nitride coating 1C that is formed on the surface of the fastener body 1B has hard, tough, fatigue-limited, lightweight, acid and alkali proof, rustproof and carbon-free material properties. The hardness of the desired titanium alloy fastener 1 is around 2000 HV to 3500 HV. Therefore, the technique of the present invention is environment friendly and, effectively eliminates fragility, rust and corrosion problems of the conventional techniques.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A titanium alloy fastener fabrication method, comprising the steps of:
a) using titanium alloy to make a fastener body subject to a predetermined design;
b) applying a heat treatment to said fastener body to harden said fastener body; and
c) applying a nitrogen treatment to said fastener body to form a titanium nitride coating on the whole surface of said fastener body.

2. The titanium alloy fastener fabrication method as claimed in claim 1, wherein said step b) of applying a heat treatment to said fastener body to harden said fastener body further comprising a sub step of repeating said heat treatment at least once to harden said fastener body.

3. The titanium alloy fastener fabrication method as claimed in claim 1, wherein said titanium nitride coating has a hardness around 2000 HV to 3500 HV.

4. The titanium alloy fastener fabrication method as claimed in claim 3, wherein the finished titanium alloy fastener is a screw.

5. The titanium alloy fastener fabrication method as claimed in claim 3, wherein the finished titanium alloy fastener is a screw nut.

6. A titanium alloy fastener comprising a fastener body prepared from titanium alloy and hardened through a heat treatment, and a titanium nitride coating covering the whole surface of said fastener body.

7. The titanium alloy fastener as claimed in claim 6, which is a screw.

8. The titanium alloy fastener as claimed in claim 6, which is a screw nut.
